(19) United States
(12) Patent Application Publication
(10) Pub. No.: US 2009/0081402 A1
(43) Pub. Date: Mar. 26, 2009

(54) Composite gear

(76) Inventors: Koji Tomoda, Nigoya-shi (JP); Yoshihiro Shimazaki, Kanagawa (JP); Kyosuke Uemura, Tokyo (JP); Tsunao Kenmochi, Nagoya-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/283,178

(22) Filed: Sep. 10, 2008

Related U.S. Application Data
(60) Provisional application No. 60/993,443, filed on Sep. 12, 2007.

(51) Int. Cl. B32B 3/02

(52) U.S. Cl. 428/66.1; 264/250

(57) ABSTRACT

The gear wheel of the present invention comprises a core, and teeth, in which said core comprises a first material, said teeth comprising the first material of the core together with a second material molded thereon as a skin, wherein the thickness of said skin at root of the teeth is more than the thickness of said skin at pitch line of the teeth.

### CROSS REFERENCE TO RELATED APPLICATIONS

This application claims the benefit of U.S. Provisional Application No. 60/993,443, filed Sep. 12, 2008.

### FIELD OF THE INVENTION

This invention relates to gears. More particularly, this invention relates to composite gears made from thermoplastic materials such as thermoplastic polymers.

### BACKGROUND

Gears made from a rigid material such as metal or metal alloys are well known and are used in many applications. Such gears may withstand high torque load forces, but have a significant shortcoming in that they generate a great deal of noise when they mesh with other metal gears.

Gears made from a thermoplastic material are also known and have been used to reduce the noise generated by metal gears. However, thermoplastic gears have significant disadvantages, in that they cannot withstand high torque load forces without damaging their gear teeth, and are more susceptible to wear than metal gears.

To solve the respective problems of metal and thermoplastic gears, several attempts have been made to manufacture composite gears (cf. U.S. Pat. No. 3,719,103, U.S. Pat. No. 4,143,973, U.S. Pat. No. 5,722,295, U.S. Pat. No. 5,852,951). As a recent development, WO2007/050397 discloses an improved composite gear wheel, which includes a core, and teeth, in which the core comprises a first material. The teeth comprise the first material of the core together with a second material molded thereon as a skin, the second material imparting a desired property to the gear wheel, for example lubricity or wear resistance.

### SUMMARY OF THE INVENTION

The gear construction of the present invention has been designed to provide improved gears having excellent strength. More particularly, the present invention has an improved shape on the skin which covers a teeth of gear wheel.

In one embodiment, the gear wheel of the invention comprises a gear wheel comprising a core and teeth, in which said core comprises a first material, said teeth comprising the first material of the core together with a second material molded thereon as a skin, wherein the thickness of said skin at root of the teeth is more than the thickness of said skin at pitch line of the teeth. Preferably, the thickness of said skin at root of the teeth is 1.5-10 times of the thickness of said skin at pitch line of the teeth. And, preferably, said core comprises a reinforced resin and said skin comprises an unreinforced resin.

In a further embodiment of the invention, a method for manufacturing a gear wheel comprising the steps of;

I. molding a core from a first material, said core having teeth,

II. allowing the first material to solidify,

III. molding a skin made of a second material over the teeth, so that the thickness of said skin at root of the teeth can be more than the thickness of said skin at pitch line of the teeth. Preferably, the thickness of said skin at root of the teeth is 1.5-10 times of the thickness of said skin at pitch line of the teeth. And, preferably, said core comprises a reinforced resin and said skin comprises an unreinforced resin.

Conventionally, the skin coating teeth of gear was formed in such a way that the thickness of the skin is equal. The gear wheel of the present invention has a relatively thicker skin at the root of the teeth. This characteristics bring the following technical effects.

The second material having higher elongation than that of the first, when it exists relatively rich at the root of the gear, allows it to tolerate a larger strain. The root of the gear starts yielding from the skin, then gradually propagates into the depth. Therefore, a thinner skin result in earlier failure than the case of thick skin.

### BRIEF DESCRIPTION OF THE DRAWINGS

FIG. 1 shows a schematic diagram of one embodiment of the gear wheel of the invention.

FIG. 2 shows a schematic diagram illustrating the technical effect of the present invention.

FIG. 3 shows a schematic diagram of another embodiment of the gear wheel of the invention.

### DETAILED DESCRIPTION OF THE INVENTION

Gears usually break at the root of the teeth when overloaded. Design calculations for the strength determine the stress there. A most commonly used formula is the Lewis equation where stress equals tangential force divided by module, profile factor and tooth width. With this equation, it is clear that the only design parameters that could dictate the strength are the module and the tooth width besides the material properties. It is also a well know fact that the radius at the tooth root is very important for controlling the stress concentration there. It is, however, also a fact that the radius must not erode the region of the tooth profile for meshing. So, this is usually the end of discussion with respect to improving the strength of a given gear profile.

As for material selection for gears, a resin grade with a large amount of reinforcement might be chosen, yet that choice might defeat the intent due to its sensitivity to stress concentration, small deflection of the tooth not allowing other teeth to come into sharing the load, and poor lubricity at the contact surface. Therefore, the gear strength might only be further maximized by controlling the deflection, lubricity (wear performances) and contact pressure in addition to the usual design parameters as discussed above in a holistic approach.

Making the gear dominantly in reinforced resins such as the case as discussed where the core is made with GR nylon, could also be advantageous in terms of making the gear more dimensionally stable since the thermal expansion and moisture growth are smaller with GR nylon than unreinforced nylon.

In summary, the design goal could be as the following.

A) Minimizing stress concentration

B) Maximizing the allowable strain at the root of tooth where stress inevitably concentrates.

C) Using a high strength material with a large allowable strain.

D) Using a high strength material with reinforcements to its properties limit; conventional gear forms molded in reinforced resins do not often achieve the performances proportional to the materials' properties.

E) Using a reinforced resin for the core will result in a better precision than the case of unreinforced resin.

This invention provides an improved gear wheel, in particular, to an improved gear wheel wherein a skin layer is formed in such a way that the thickness of said skin at root of the teeth is more than the thickness of said skin at pitch line of the teeth, thereby maximizing the allowable strain at the root of tooth. In other words, the concept of the present invention is based on the above B).

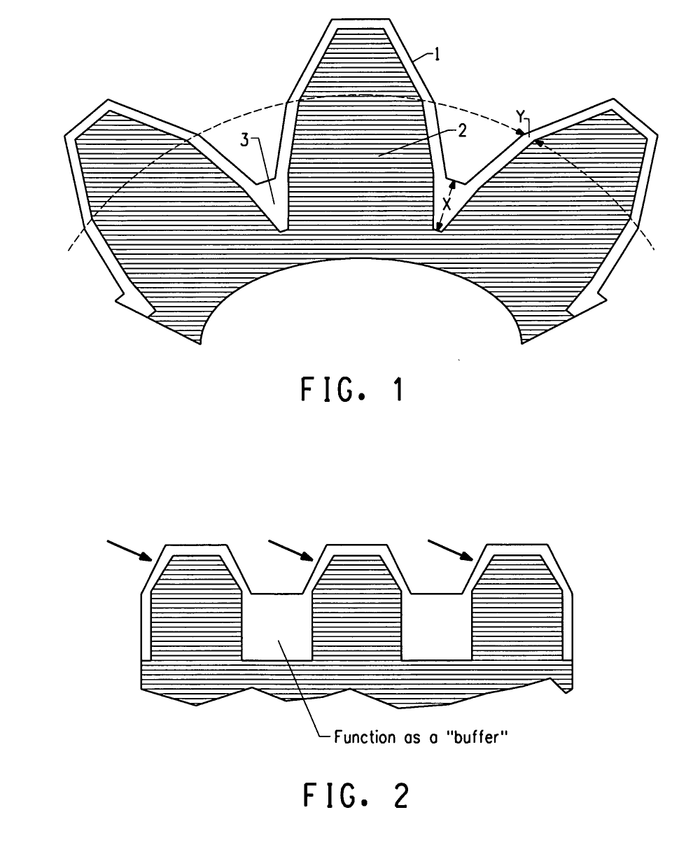

FIG. 1 shows a schematic diagram of one embodiment of the gear wheel of the invention. In this embodiment, the skin layer conforms to normal gear profile, generally of involutes, at its surface while it bonds to the gear core at the inner side. The thickness of the skin (1) at the root of the teeth (2), which is shown as ‘X’ is deeper in the radial direction than the thickness of the skin (1) at the pitch line of the gear, which is shown as ‘Y’. Pitch line, which is shown as dotted circle line in the figures, is usually called reference diameter or working pitch diameter. The line divides the tooth profile to addendum and dedendum. When gears mesh, sliding on tooth profile takes place changing its direction at this line. Therefore, the thickness here has its significance as to the wear performances of gears.

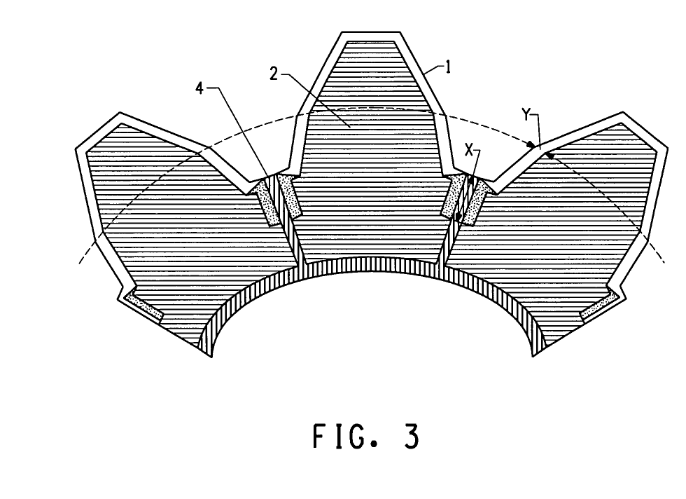

The thickness of the skin at the root of the teeth, “X”, is defined as the length between the outer surface of the skin and the outer surface of the core in the radial direction of the gear wheel. The core is a part constituting a circular shape by one part (cf. FIG. 1) or in combination (cf. FIG. 3). In case that one part has a core part and a tooth part as illustrated in FIG. 1, the core is an inner part, to which a sticking-out tooth is attached.

The thickness of the skin at the pitch line of the teeth, “Y”, is defined as the length between the outer surface of the skin and the outer surface of the tooth in the circumferential direction of the gear wheel.

With this configuration, the profile of the core is similar to a slender or tall height gear itself, yet it could be less demanding as to its precision since the skin will conform to the exact gear profile regardless the core geometry. The tooth height of the core could be determined not only as the resultant of the thickness of the skin, but as the outcome of calculations done with given combinations of the skin and the core materials. The strength of the core, since it is now relatively slender, is dictated by flexure than shear unlike the case of a monolithic stub gear.

FIG. 2 schematically shows the technical effect caused by the present invention. The double layer gear of this concept could be designed for the flexural stress at the profile section of the tooth rather than the root where the surrounding thick skin supports. The thick skin at the gear root provides a buffer for the surging stress there as the case of a larger mass deforms more than a small one. By using a high elongation material for the skin, such as nylon, and a stiff material for the core, such as glass reinforced plastic, the maximum gear strength could be achieved when the flexure stress of the core and the shear stress of the skin reach their strength at the same time.

The optimum thickness of the skin could be determined by calculations in which shear stress at the gear root and the flexural stress the core are to reach the strength of each material in use.

FIG. 3 shows another embodiment of the present invention where segmented gear teeth are to be put together by the bonding layer (4). This configuration could enable complex gears such as worm wheels with some undercuts be made. The bonding layer (4) consists of the same composition as the skin (1). Therefore, as a formed gear wheel, the bonding layer (4) functions as a skin. The thickness of the skin (1) at root of the teeth (2), which is shown as ‘X’ is more than the thickness of the skin (1) at pitch line of the teeth (2), which is shown as ‘Y’.

As in the case the previous design (FIG. 1), the thick skin wall section at the root of the gear teeth means that the portion could be more tolerant to stress concentration there; hence the skin there could deform more than a case of constant wall section geometry.

The thickness of said skin at root of the teeth is preferably 1.5-10 times of the thickness of said skin at pitch line of the teeth, and more preferably 1.5-10 times of the thickness of said skin at pitch line of the teeth. Too thick skin layer at the root can bring a weakness to the gear wheel, depending on the material's modulus of elasticity.

The shape of the teeth is not limited; however, the teeth of the present gear wheel have a relatively longer or slender profile of the first material, which is inside the teeth, as compared with the gear wheel without thick skin at the root. In case a gear wheel with the same surface profile is manufactured, the gear wheel of the present invention has a longer and slender profile for the first material constituting the teeth because of the thicker skin at the root. For a constant tangential force at meshing, the subject gear will deform more than the case in which the skin or the second material has uniform thickness. With the subject gear, the corners of both the skin and the core at the gear root are not in the close proximity each other; hence the vulnerable areas by stress concentrations are alike. The core with smaller elongation than the skin will not reach its structural limit prior to the skin that is strained more than the core root in the depth. The gear as a whole could perform well as it is not to be dictated by the strength of only one material in use.

It is evident that the mechanical properties of the first and the second materials themselves will determine the optimum geometrical balance as to the appropriate thickness of the skin at the gear root relative to the other areas. Specific design configuration of a gear by the concept thus far described could be determined through elaborate structural calculations such as those by Finite Element Analysis.

Wear and abrasion performances of dissimilar materials in contact are known to be good in some cases and the proposed geometrical configuration of the gears could readily offer that benefit if the first and second materials are properly chosen.

The first and second materials can comprise any thermoplastic polymer that imparts a desired property to the gear wheel. In one embodiment of the invention, the first material will be a rigid polymer that imparts the desired flexural strength, rigidity and impact resistance to the core, and the second material will be a softer polymer that imparts a quieter performance in use. The polymers may be of the same species, for example both polyamides, or different species, for example a polyamide and a polyester. Examples of polymer combinations that can be used in both materials are polyamide+polyester block copolymer (Zytel®-Hytrel®), polyesters, (Ryntie®/Crastin®-Rynite®/Crastin®), polyacetal+polyacetal (Delrin®-Delrin®), polyacetal+polyamide of either unreinforced or glass/mineral reinforced (Delrin®-Zytel®/Minlon®), all available from the Du Pont Company (Wilmington, Del.). One skilled in the art will be able without undue experimentation to specify the correct molecular weight grades to comprise the two materials.

The polymers that can be used in the product of the invention are not limited to the commercial materials that are listed above. Any combination of polymers can be used that can be bonded. No particular limitation is imposed on the thermoplastic polymers that can be used in the manufacture of the product of the invention. Examples of thermoplastic polymers include aromatic polyesters such as polyethylene terephthalate, polybutylene terephthalate, polyethylene naphthalate, and polybutylene naphthalate; polyolefins such as polyethylene and polypropylene; polyacetals (homopolymer and copolymer); polystyrene, styrene-butadiene copolymers, acrylonitrile-butadiene-styrene copolymers, styrene-butadiene-acrylic acid (or its ester) copolymers, and acrylonitrile-styrene copolymers; polyvinyl chloride; polyamides; poly(phenylene oxide); poly(phenylene sulfide); polysulfones; polyether-sulfones; polyketones; polyether-ketones; polyimides; polyether-imides; polybenzimidazole; polybutadiene and butyl rubber; silicone resins; fluororesins; olefin-based thermoplastic elastomers, styrene-based thermoplastic elastomers, urethane-based thermoplastic elastomers, polyester-based thermoplastic elastomers, polyamide-based thermoplastic elastomers, and polyether-based thermoplastic elastomers; polyacrylate-based, core-shell type, multi-layered graft copolymers; and modified products thereof. These thermoplastic resins may be used in combination of two or more species.

Liquid crystalline polyesters (LCP's) can be used in the manufacture of the product of the invention. Examples of LCP's are those prepared from monomers including;

(i) naphthalene compounds such as 2,6-naphthalenedicarboxylic acid, 2,6-dihydroxynaphthalene, 1,4-dihydroxynaphthalene, and 6-hydroxy-2-naphthoic acid;

(ii) biphenyl compounds such as 4,4′-diphenyldicarboxylic acid and 4,4-dihydroxybiphenyl;

(iii) p-substituted benzene compounds such as p-hydroxybenzoic acid, terephthalic acid, hydroquinone, p-aminophenol, and p-phenylenediamine, and nucleus-substituted benzene compounds thereof (nucleus substituents being selected from chlorine, bromine, a C1-C4 alkyl, phenyl, and 1-phenylethyl); and

(iv) m-substituted benzene compounds such as isophthalic acid and resorcin, and nucleus-substituted benzene compounds thereof (nucleus substituents being selected from chlorine, bromine, a C1-C4 alkyl, phenyl, and 1-phenylethyl).

Among the aforementioned monomers, liquid crystalline polyesters prepared from at least one or more species selected from among naphthalene compounds, biphenyl compounds, and p-substituted benzene compounds are more preferred as the liquid crystalline polyester of used in the manufacture of the present invention.

Among the p-substituted benzene compounds, p-hydroxybenzoic acid, methylhydroquinone, and 1-phenylethylhydroquinone are particularly preferred.

In addition to the aforementioned monomers, the liquid crystalline polyester used in the present invention may contain, in a single molecular chain thereof, a polyalkylene tetrphthalate fragment which does not exhibit an anisotropic molten phase. In this case, the alkyl group has 2-4 carbon atoms.

Substances or additives which may be added to the thermoplastic used in the manufacture of the product of this invention, include, but are not limited to, heat-resistant stabilizers, UV absorbers, mold-release agents, antistatic agents, slip agents, antiblocking agents, lubricants, anticlouding agents, coloring agents, natural oils, synthetic oils, waxes, organic fillers, inorganic fillers, and mixtures thereof.

Examples of the aforementioned heat-resistant stabilizers, include, but are not limited to, phenol stabilizers, organic thioether stabilizers, organic phosphite stabilizers, hindered amine stabilizers, epoxy stabilizers and mixtures thereof. The heat-resistant stabilizer may be added in the form of a solid or liquid.

Examples of UV absorbers include, but are not limited to, salicylic acid UV absorbers, benzophenone UV absorbers, benzotriazole UV absorbers, cyanoacrylate UV absorbers, and mixtures thereof.

Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned.

The coloring agent may be either pigments or dyes. Inorganic coloring agents and organic coloring agents may be used separately or in combination the invention.

Bonding of the first and second materials may be accomplished by any means known to one skilled in the art. In one embodiment of the invention bonding can be accomplished by using as a second material a polymer that has a higher latent heat of fusion than the first material. In the process for manufacturing the gear wheel, the second material is molded onto a core that comprises the first material. Without wishing to be constrained by mechanism, it is possible that the residual enthalpy from the cooling and crystallization of the second material causes a remelting of a thin layer of the first material and subsequent fusion and hence bonding of the first and second materials under the pressure of molding. In a further embodiment of the invention, bonding is accomplished by use of a primer or adhesive layer between the first and second materials. For example, an isopropanol based bonding agent for polyamide resins with the product name of “Cling-Aid” by Yamasei Kogyo Co., Ltd., is an example of such a primer when the first and second materials to be used are grades of polyamide. “Cling-Aid” comprises a solution of gallic acid (CAS number 149-91-7) in isopropanol.

The second material to be molded over the first need to be thin enough not to lose the compound section modulus by both the core and the skin. If excessively thick, the modulus could be significantly affected because that the outer most layer of the section has a greater impact to the modulus calculation than the core. The required thickness of the skin in terms of its lubricity/wear resistance contribution is 0.2-0.5 depending on the gear module: The greater the module, the thicker the skin could be without changing the inevitable modulus loss due to the softer material for the skin than the core, yet the thickness should be kept minimum so long as it allows the material flow.

Making the skin thick at the root of gear teeth does not mean the larger loss of the modulus as the thickness varies only in the radial direction. There may be a concern about that the uneven wall thickness (thin at the pitch line and thick at the root) could cause a problem of inconsistent plastic flow and the resultant weldlines formed at thin sections. This, however, could be overcome by properly locating the gate (from which plastic is to be filled) and the vent (from which compressed gas by plastic flow is to be released). Also, weldlines likely to be formed at the tip of the gear teeth would not be a problem as the area will not be stressed much. So, the thick and thin as a result of non-proportional core and the final part geometry will not spoil the concept of this invention.

The tensile strength of the bond between the first material of the core and the second material of the skin should be greater than 20 Mpa as measured by the tensile measurement perpendicular to the plane of the bond. Preferably the tensile strength should be greater than 50 Mpa, and most preferably greater than 80 Mpa.

The invention further relates to a process for manufacturing a composite gear wheel that comprises thermoplastic polymers. In one embodiment of the invention, the process comprises the steps of
i. molding a core from a first material, said core having teeth,
ii. allowing the first material to solidify,
iii. molding a skin made of a second material over the teeth, so that the thickness of said skin at root of the teeth can be more than the thickness of said skin at pitch line of the teeth.

Between II and III, a step of applying a primer to the core before the step of molding the skin can be optionally inserted. Primer can be applied by any means known to one skilled in the art. For example, manual application by means of a brush.

Molding of the core from the first material can be accomplished by any molding method known to those skilled in the art. For example, injection molding machines are well known, and produced my manufacturers such as Toshiba, Sumitomo, Nissei, Fanuc, Battenfeld, Engels. In the injection molding process molten polymer is injected under pressure into a mold of the required shape and dimensions. The mold is cooled and the final part ejected. For the process of the invention, the ejected part is used, after trimming if necessary, as a core for a second injection of the second material. The core needs to be firmly held in the mold so that the pressure to be exerted by the polymers of the second injection will not deform or dislocate the core then causes dimensional inaccuracy of the gear. The movement of the core in the mold is usually called “core shift” and it is particularly significant when the pressure imbalance becomes large. In order to minimize this imbalance, the flow path of the second material ought to be determined so that the pressure on the all sides of the core at any given timing of the filling could cancel each other. For example, when the melt front advancement in the front side of the core and the back is equal, the pressure by it on the core could be assumed in an equilibrium state. The second material forming the skin over the core is inevitably to be filled from one side, namely the cavity side. So, if there is no particular consideration is given, the core will deform toward the core side as the melt spreads faster on the cavity side than the core side. In one embodiment of the invention, perforations are optionally provided on the core are meant to provide the flow path connecting the both sides of the core, then to balance the pressure on the core.

We claim:

1.) A gear wheel comprising a core, and teeth, in which said core comprises a first material, said teeth comprising the first material of the core together with a second material molded thereon as a skin, wherein the thickness of said skin at root of the teeth is more than the thickness of said skin at pitch line of the teeth.

2.) The gear wheel of claim 1 in which the thickness of said skin at root of the teeth is 1.5-10 times of the thickness of said skin at the pitch line of the teeth.

3.) The gear wheel of claim 1 in which said core comprises a reinforced resin and said skin comprises an unreinforced resin.

4.) A method for manufacturing a gear wheel comprising the steps of;
I. molding a core from a first material, said core having teeth,
II. allowing the first material to solidify,
III. molding a skin made of a second material over the teeth, so that the thickness of said skin at root of the teeth can be more than the thickness of said skin at pitch line of the teeth.

5.) The method of claim 4 in which the thickness of said skin at root of the teeth is 1.5-10 times of the thickness of said skin at the pitch line of the teeth.

6.) The method of claim 4 in which said core comprises a reinforced resin and said skin comprises an unreinforced resin.
